(19) United States
(12) Patent Application Publication
(10) Pub. No.: US 2016/0197417 A1
(43) Pub. Date: Jul. 7, 2016

(54) ELECTRICAL COMMUNICATION WITH 3D-PRINTED OBJECTS

(71) Applicant: Voxel8, Inc., Somerville, MA (US)

(72) Inventor: Travis Alexander Busbee, Somerville, MA (US)

(21) Appl. No.: 14/984,664

(22) Filed: Dec. 30, 2015

Related U.S. Application Data
(60) Provisional application No. 62/099,370, filed on Jan. 2, 2015.

(51) Int. Cl. H01R 9/24; H01R 43/20; H01R 43/18; H01R 13/40; H01R 13/03

(52) U.S. Cl. CPC H01R 9/2416; H01R 13/40; H01R 13/03; H01R 43/18; H01R 43/20; B33Y 10/00

(57) ABSTRACT

Electrical signal and power transmission between two or more 3D-printed parts, 3D-printed parts and printed circuit boards, and/or 3D-printed parts and standard wire harnesses are facilitated by inserting electrically conductive magnets in sockets formed in each of the 3D-printed parts during 3D printing; by inserting electrically conductive magnets in sockets formed in a first part and inserting a biasable, electrically conductive object in the sockets formed in a second part during 3D printing; by 3D printing an electrically conductive feature having a biasable face in a first part and forming an electrically conductive pad/socket on a second part; or by affixing a printed circuit board in a first part and connecting the first part to a second part having contact pins and contact pads formed in the second part.

### CROSS REFERENCE TO RELATED APPLICATION

This application is a non-provisional patent application claiming priority of U.S. Provisional Patent Application No. 62/099,370, filed Jan. 2, 2015, which is incorporated by reference herein in its entirety.

### FIELD OF THE INVENTION

Embodiments of the invention relate to embedding electronic systems into three-dimensional (3D) printed objects and, more particularly, to systems and methods for electric communication with such objects.

### BACKGROUND

While many 3D-printed objects or parts are fully contained systems that have no wired connection to systems outside of the object or part, others require inputs and outputs to other systems for electrical and/or electronic communication, such as external power or external signal analysis. An early mechanism for connecting a printed object or part to external systems included printing exposed pads of conductive ink and electrically coupling to them, e.g., using alligator clips and the like. This is a poor connection mechanism for multiple reasons, including, for example, variable contact resistance, degradation of the connection point due to repeated mechanical compression and abrasion on a relatively fragile printed trace, and dimensional limitations on the minimum spacing between adjacent connection points before it becomes difficult to connect to with clips.

### SUMMARY

For these and other reasons, a need exists for a more broadly applicable electrical connection mechanism during 3D printing. More specifically, a reliable, robust, and repeatable 3D-printed mechanism for making electrical connections is desirable. For example, for the purpose of illustration and not limitation, in some embodiments, magnetic/electrical connections may be inserted into corresponding receiving apertures and, in other embodiments, press-fit objects or parts that align electrical connections and frictionally retain a closed circuit between the individual parts of the electrical connection may be used.

In an aspect, some embodiments of the invention relate to a method of making an electrical connection to a three-dimensionally printed object, including forming the printed object by three-dimensional printing, the printed object defining a socket disposed proximate an electrically conductive lead in the printed object. A magnet is inserted into the socket to form an electrical contact between the magnet and the electrically conductive lead.

One or more of the following features may be included. The forming step may include three-dimensionally printing a portion of the object with a structural material and printing the electrical lead with a functional material. The structural material may be, e.g., a thermoplastic polymer, a thermosetting polymer, a liquid crystalline polymer, a wax, a composite, a ceramic, a metal, a glass, and/or a bulk metallic glass. The functional material may be, e.g., a conductive, resistive, magnetic, dielectric, piezoelectric, or semiconductive material. The functional material may include silver, or a silver-containing polymer composite ink.

The inserting step may occur prior to curing and/or drying of the electrical lead. The magnet and the socket may be dimensioned to provide an interference fit. The socket may be formed with a reduced size opening, to retain the magnet after insertion. For example, after the magnet is inserted into the socket, a rim may be printed over the top edge of the magnet to retain the magnet in the socket. The magnet may be contacted with an external wire. The external wire may directly contact the magnet. A conductive ball may be interdisposed between the external wire and the magnet.

The printed object may define a plurality of additional sockets proximate a plurality of additional electrical leads embedded in the printed object. The method may further include the step of inserting additional magnets into the additional sockets to form additional electrical contacts. The magnets may be contacted with external wires. The external wires may be arranged in a connector to contact simultaneously the magnets. The connector may include a plurality of conductive balls attached to the external wires. The conductive balls may be constrained to allow only uniaxial movement within the connector to ensure contacting simultaneously the magnets. The connector may include a three-dimensionally printed object. At least one of the external wires may include a conductive material printed on a non-conductive substrate. The connector may be mated to the printed object.

The magnet may include a conductive coating. A composition and thickness of the conductive coating may be tuned to attain a predetermined contact resistance.

An electromagnetic head may be used to automate the process of picking and placing magnets or ferromagnetic materials into three-dimensionally printed parts.

The socket and magnet may define complementary shapes. For example, the socket may define a slot shaped and sized to receive the magnet. The magnet may be fully embedded in the socket, and the magnet may be used to attract a contact pin into the socket to form an electrical contact between the contact pin and a conductive pad in the socket.

The magnet may be used to actuate mechanical interlocking with a second printed object. For example, the socket may define a slot and the second printed object may define a printed protrusion that fits into the slot.

In another aspect, embodiments of the invention relate to an article including a three-dimensionally printed object defining a socket disposed proximate an electrical lead embedded in the printed object. A magnet is disposed in the socket, forming an electrical contact between the magnet and the electrical lead.

One or more of the following features may be included. The three-dimensionally printed object may include a structural material and the electrical lead may include a functional material. The magnet and the socket may be dimensioned to provide an interference fit. An external wire may contact the magnet, e.g., directly contact the magnet. Alternatively, a conductive ball may be interdisposed between the external wire and the magnet.

The printed object may define a plurality of additional sockets proximate a plurality of additional electrical leads embedded in the printed object, and additional magnets may be inserted into the additional sockets to form additional electrical contacts. The magnets may be contacted with external wires. The external wires may be arranged in a connector to contact simultaneously the magnets. The connector may include a plurality of conductive balls attached to the external wires. The conductive balls may be constrained to allow only uniaxial movement within the connector to ensure contacting simultaneously the magnets. The connector may include a second three-dimensionally printed object. At least one of the external wires may include a conductive material printed on a non-conductive substrate. The connector may be mated to the printed object.

The magnet may include a conductive coating. A composition and thickness of the conductive coating may be tuned to attain a predetermined contact resistance.

The socket and magnet may define complementary shapes, e.g., the socket may define a slot shaped and sized to receive the magnet.

The magnet may be fully embedded in the socket, and may attract a contact pin into the socket to form an electrical contact between the contact pin and a conductive pad in the socket. The magnet may actuate mechanical interlocking with a second printed object. For example, the socket may define a slot and the second printed object may define a printed protrusion that fits into the slot.

In yet another aspect, some embodiments of the present invention relate to a method of making an electrical connection to a multi-part, three-dimensionally printed object. In some variations, the method includes forming a first part of the printed object by three-dimensional printing. A socket is formed in the first part proximate a first electrically conductive lead, the first part further including at least one press-fit part. An electrically conductive material is inserted into the socket in the first part to form an electrical contact between the material and the first electrically conductive lead. A second part of the printed object in formed by three-dimensional printing, wherein a socket is formed in the second part proximate a second electrically conductive lead, the second part further including at least one press-fit part. A biasable, electrically conductive object, e.g., a metallic sphere electrically coupled to a spring, is inserted into the socket in the second part to form an electrical contact between the object and the second electrically conductive lead. The first part is press-fitted to the second part to mechanically connect the first part to the second part and to form an electrical communication between the first electrically conductive lead and the second electrically conductive lead.

In some variations, the biasable, electrically conductive object includes a metallic sphere electrically coupled to a spring and/or a spring-loaded electrically conductive pin. In some implementations, the biasable, electrically conductive object holds the three-dimensionally printed object in an electrically coupled position and orientation via a three-dimensionally printed mechanical interlocking feature.

In still another aspect, some embodiments of the present invention relate to a method of making an electrical connection to a multi-part, three-dimensionally printed object. In some embodiments, the method includes the steps of forming a first part of the printed object by three-dimensional printing, wherein a portion of the first part is elastic and compliant. An electrically conductive feature is three-dimensionally printed proximate the compliant first part, wherein at least some portion of the electrically conductive feature includes an external biasable face. A second part of the object is formed by three-dimensional printing, wherein an electrically conductive pad and/or an electrically conductive socket is formed by printing conductive ink in a location that causes the electrically conductive feature of the first part to register and/or align with the electrically conductive pad and/or the conductive socket of the second part when the first and second parts are properly mechanically joined.

In some variations, mechanical joining includes causing a slight deflection of the electrically conductive feature of the compliant portion of the first part, to ensure consistent, reliable electrical contact with the electrically conductive pad and/or the electrically conductive socket of the second part. In some implementations, the first and second parts of the three-dimensionally printed object are held in place by a snap-fitting mechanical interlock that is three-dimensionally printed as a component of each of the first and the second parts.

In a further aspect, some embodiments of the present invention relate to a method of making an electrical connection between three-dimensionally printed composite parts of a printed object. In some embodiments, the method includes the steps of forming a first part of the printed object by three-dimensional printing. A printed circuit board is affixed, e.g., embedded, in the first part of the printed object. A second part of the object ifs formed by three-dimensional printing, wherein some portion of the second part includes embedded electrically conductive leads. The first part is coupled to the second part, such that the printed circuit board is in electrical communication with corresponding electrically conductive leads in the second part when the first and second parts are properly coupled.

In some variations, the second part is formed by forming electrically conductive pads and/or electrically conductive sockets in the second part and inserting uniaxially biasable electrically conductive objects into the electrically conductive pads and/or the electrically conductive sockets to make electrical connections at multiple locations on the printed circuit board. In some applications, the electrically conductive pads and/or electrically conductive sockets may be formed to orient and hold the printed circuit board.

In some implementations, the printed circuit board is mechanically attached to the three-dimensionally printed object using an interference fit with the electrically conductive socket, using an interference fit with the electrically conductive pad, using a snap fit with the electrically conductive socket, using a snap fit with the electrically conductive pad, by screwing the printed circuit board into the electrically conductive socket, and/or by inserting the printed circuit board into the socket and three-dimensional printing over the printed circuit board. In another implementation, the printed circuit board is reversibly attached to the three-dimensionally printed part using magnetic force.

### BRIEF DESCRIPTION OF FIGURES

FIG. 1A is a schematic drawing of a 3D-printed part including a pair of magnetic electrical connections disposed in corresponding openings in the part and forming electrical socket connections, in accordance with an embodiment of the invention;

FIG. 1B is a schematic drawing of the 3D-printed part of FIG. 1A, with a magnetically and electrically conductive metal ball contacting one of the magnets in the electrical socket connection in accordance with an embodiment of the invention;

FIG. 1C is a schematic drawing of the 3D-printed part of FIG. 1A, with an electrical wire (lead) soldered to the metal ball of FIG. 1B, in accordance with an embodiment of the invention;

FIG. 2A is a schematic drawing of a 3D-printed part having a 7×2 array of electrical socket connections, in accordance with an embodiment of the invention;

FIG. 2B is a schematic drawing of the 7×2 array of electrical socket connections of FIG. 2A with electrical wires (leads) soldered to corresponding metal balls, in accordance with an embodiment of the invention;

FIG. 3A is a schematic drawing of a first 3D-printed part having a 7×2 array of electrical socket connections, in accordance with an embodiment of the invention;

FIG. 3B is a schematic drawing of a second 3D-printed part having a 7×2 array of metal balls, in accordance with an embodiment of the invention;

FIG. 3C is a schematic drawing of the 3D-printed parts of FIGS. 3A and 3B magnetically connected to each other, in accordance with an embodiment of the invention;

FIG. 4A is schematic drawing of a disassembled, multi-part 3D-printed object, in accordance with an embodiment of the invention;

FIG. 4B is a schematic drawing of the 3D-printed object of FIG. 4A fully assembled, in accordance with an embodiment of the invention;

FIG. 5 is a schematic cross-sectional drawing single electrical connection between two 3D-printed parts, relying on the compliance of an insulated metallic wire, in accordance with an embodiment of the invention;

FIG. 6 is a schematic cross-sectional drawing of a single electrical connection, including a conductive spring, between two 3D-printed parts, in accordance with an embodiment of the invention;

FIGS. 7A and 7B are schematic drawings of an illustrative embodiment of a 3D-printed screw terminal, in accordance with the present invention;

FIG. 8A is a schematic drawing of an illustrative embodiment of a 3D-printed hearing aid, in accordance with the present invention;

FIG. 8B is a schematic drawing of the hearing aid of FIG. 8A, including the electrical and mechanical connections, in accordance with the present invention;

FIG. 9A is a schematic drawing of an illustrative embodiment of a 3D-printed base portion for a quadcopter drone, in accordance with the present invention;

FIG. 9B is a schematic drawing of an illustrative embodiment of an electrical coupling of a printed circuit board control module to the 3D-printed base portion of FIG. 9A, in accordance with the present invention; and

FIG. 10 is a schematic drawing of an illustrative embodiment of a 3D-printed watch, in accordance with the present invention.

### DETAILED DESCRIPTION

Magnetic-Type Electrical Connections and their Manufacture

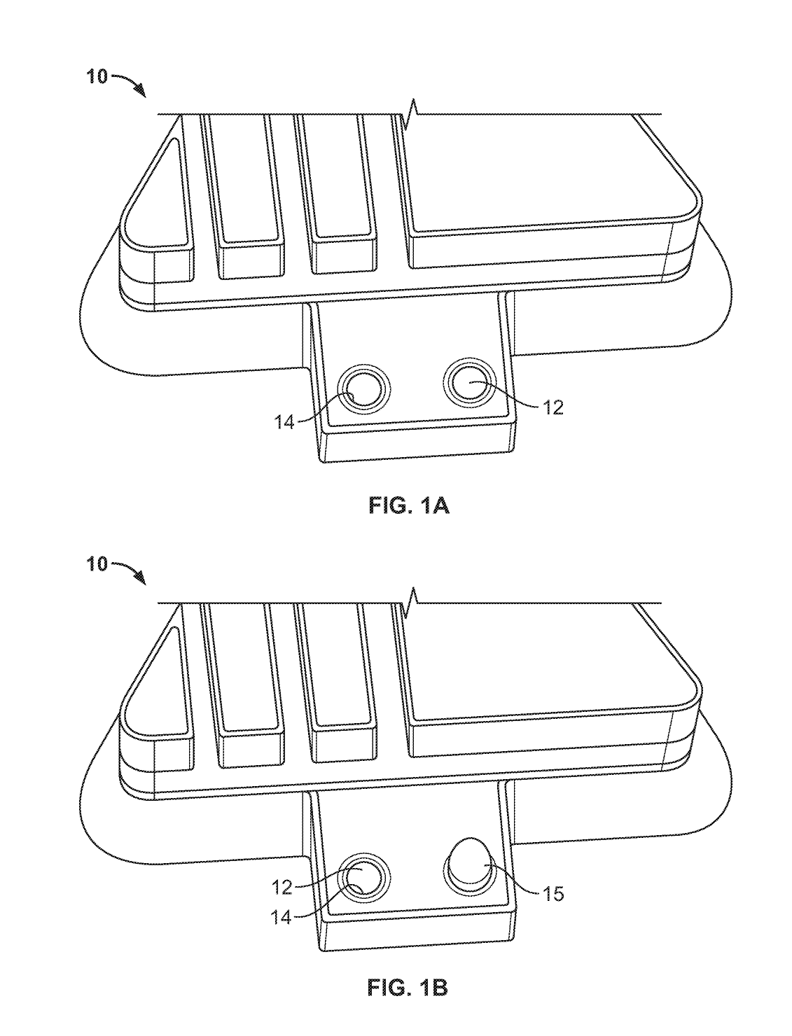

As shown in FIGS. 1A-1C, in accordance with some embodiments of the invention, electrical connections to 3D-printed objects or parts 10 may be obtained by inserting, e.g., snapping in, ferromagnetic materials and/or magnets 12, e.g., strong, small, cylindrical, rare earth magnets and the like, into sockets or openings 14 formed in the objects or parts 10 during 3D printing. In one variation, the magnets 12 may be made of an electrically conductive material. In another variation, the magnets 12 are not conductive; however, an electrically conductive coating on the magnet 12 can be varied in thickness and/or composition in order to act as a resistor of tunable value. Although the magnets 12 shown in FIGS. 1A-1C are cylindrically shaped or substantially cylindrically shaped, magnets 12 of other sizes and shapes may be used, e.g., cylindrical magnets formed with a conical counterbore rather than a straight cylinder. Advantageously, magnets with a conical counterbore provide a larger surface area, e.g., a ring, of contact than the single point of contact of straight cylinder magnets, resulting in decreased contact resistance.

Interconnects can also be made between two magnets 12, or a magnet and a ferromagnetic material. The magnetic or ferromagnetic material can be intrinsically conductive, or can be coated with a highly conductive material such as tin, copper, nickel, silver, or gold. Furthermore, in some embodiments of the invention, one can employ materials that are not attracted to each other by using external magnets to draw them together. Moreover, the attractive force of the embedded magnets 12 may be used to actuate another type of mechanical interlocking between two printed objects 10. For example, printed protrusions on a first part may fit into printed slots on a second part to, e.g., provide a mechanically robust connection that is less sensitive to shear force.

In one aspect of the present invention, 3D printing can include printing with multiple materials having different properties and, more specifically, printing using structural materials and functional materials. Structural materials provide the basic structure of the 3D-printed object or part 10, while functional materials enable the object or part 10 to provide a desired function. Illustrative structural materials can include, for the purpose of illustration and not limitation, a thermoplastic polymer, a thermosetting polymer, a liquid crystalline polymer, a wax, a composite, a ceramic, a metal, a glass, and a bulk metallic glass. Illustrative functional materials can include, for the purpose of illustration and not limitation, materials that are conductive, resistive, magnetic, dielectric, piezoelectric, and semiconductive in nature.

During manufacture by 3D printing, before the peripheral walls of the socket 14 are printed, 3D-printed pads (“traces”) of an electrically conductive material, e.g., a functional ink of gold, silver, copper, platinum, or other electrically conductive material, may be printed on a base portion of the object or part 10 or within a channel in the base portion of the object or part 10. The traces electrically couple the magnet 12 and/or any electrically conductive object in electrical communication with the magnet 12, to other components printed or embedded in the part 10. Although embodiments of the invention are described in the context of a functional material providing suitable electrical conductivity, this is done for illustrative purposes only. Those of ordinary skill in the art can appreciate that functional materials may be selected from a myriad of materials that are resistive, conductive, insulative, dielectric, piezoelectric, semiconductive, and so forth.

Once the peripheral walls of the socket 14 are printed or substantially printed, and before the trace, e.g., silver ink, is fully dried or cured, ferromagnetic material or magnets 12 can be inserted into corresponding sockets 14 to ensure good bonding and reliable electrical contact between the magnets 12 and the drying traces. Optionally, instead of inserting a magnet 12 into the trace, a magnetic pad 16 may be electrically coupled to the trace before it has fully dried or cured.

Ferromagnetic materials can be picked up and placed into 3D-printed parts 10 using, for example, an electromagnet. More particularly, the electromagnet can be adapted to first attract the magnet 12 to grip it, then to repel the magnet 12 to disconnect the magnet 12 after moving it to the correct location. An electromagnetic head may allow the automation of the process of picking up and placing a plurality of magnets 12 or ferromagnetic materials into the sockets 14 of 3D-printed parts 10 using the multi-axis positioning system of the 3D printer. Alternatively, in another implementation, ferromagnetic materials or magnets 12 may be picked up and placed in corresponding sockets 14 by a combination of an electromagnet and a permanent magnet. For example, the permanent magnet can be configured to attract the magnets 12. The electromagnet may be configured, when selectively switched on or activated, to induce a repellant magnetic force sufficient to overcome the attractive force of the permanent magnet and, thereby, release the magnet 12. In short, this combination allows one to pick up and place a magnet 12 using an attractive force from a permanent magnet; then, once the magnet 12 has been placed, the magnet 12 may be released at a desired location, e.g., in a corresponding socket 14, using the electromagnet.

In another implementation, magnets 12 may also be picked and placed by having the pick and place head include an internally slideable piece of ferromagnetic material, so that when the magnet 12 is secured and properly placed, the ferromagnetic material can be retracted or moved sufficiently away from the head, such that the magnet 12 is no longer attracted to it.

Once properly placed in a socket 14, friction from a tight snap in or interference fit is generally enough to hold the magnets 12 in place. For example, during manufacture, in some implementations, the sockets 14 can be undersized, viz. the diameter of the socket 14 is smaller than the outer diameter of the magnet 12, to form a frictional interference fit with the magnet 12.

In other variations, after insertion of the magnet 12 into the socket 14, the magnet 12 can also be captured in and retained by the socket 14, using, for example, one or more of an undersized or reduced size aperture or opening at the surface, an overhanging lip, a flange, a tab, and so forth. Indeed, in some variations, to form a more secure seat for the magnet 12, a thin, e.g., plastic, rim can be 3D-printed over the magnet 12 after magnet insertion. For example, the diameter of the opening of the rim may be less than the diameter of the cylindrical magnet 12, as well as less than the diameter of the peripheral wall of the socket 14. As a result, the rim at the opening partially overlaps the outer peripheral surface of the cylinder to retain the magnet 12 permanently in place, while still leaving an exposed magnet center to complete an electrical connection.

External devices or other 3D-printed objects or parts 10 can then be electrically coupled to the magnet 12, e.g., using a ferromagnetic or magnetic material that is either intrinsically electrically conductive or has an electrically conductive coating on it. Advantageously, the electrically conductive coating material and thickness may be selectively tuned to change, inter alia, the contact resistance, e.g., to attain a predetermined contact resistance. The ferromagnetic property of the other side of the connection provides an attractive force that mechanically, i.e. magnetically, holds or adheres the electrical connection together, without the need for alligator clips or other manual connection schemes. In one embodiment, a nickel-coated steel ball 15 that can be magnetically and electrically coupled to the magnet 12 may be soldered or crimped to an external traditional wire lead 16. Using magnets 12 to make electrical connections with 3D-printed parts 10, in particular to provide an interface with 3D-printed conductive traces, provides heretofore unknown functionality and benefits in 3D-printed components and systems made from these components.

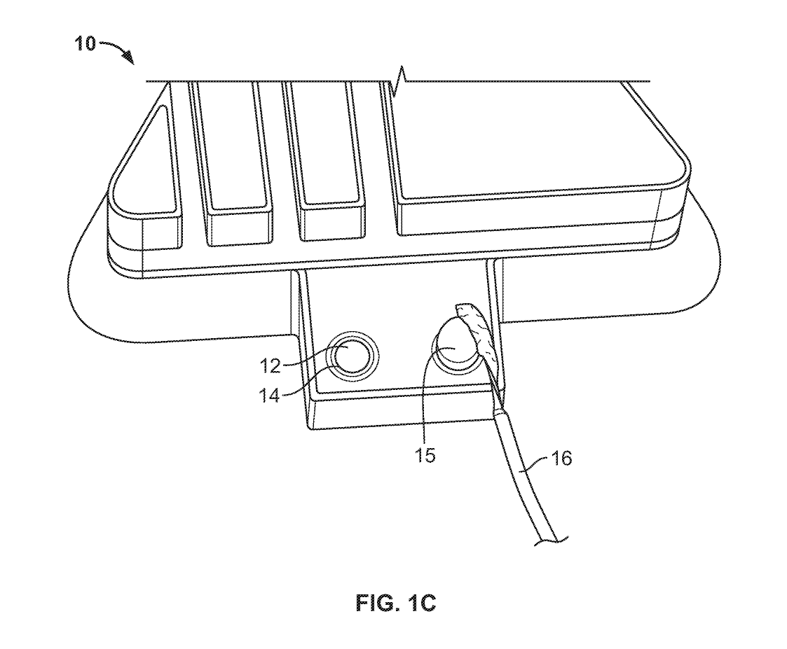

In its simplest form, the previous embodiment includes a printed trace of a functional, e.g., electrically conductive, ink connected to an embedded electrically conductive magnetic disc 12, which interfaces with a magnetic, electrically conductive, e.g., steel, ball 15 to connect one traditional metal wire lead 16 to a printed wire trace that continues into the 3D-printed object or part 20. However, this fundamental principle can also be applied readily to achieve more complex solutions to challenging problems. For example, referring to FIGS. 2A and 2B, an array of magnetic connections of various geometries and configurations may be formed on an object or part 20. In some implementations, the part 20 includes a first portion 21 and an array portion 23. For illustrative purposes only, the array portion 23 includes a 7×2 array of magnet-filled sockets 24. The magnets 22 of six of the sockets 24 are magnetically and electrically coupled to a conductive ball 25 to which a conductive wire (lead) 26 is soldered or otherwise attached. Each embedded trace 28, formed in the first portion 21 and electrically coupled to a corresponding non-contact capacitive touch sensor pad (hereinafter a contact pad 29), is in electrical and/or electronic communication with at least one array pair.

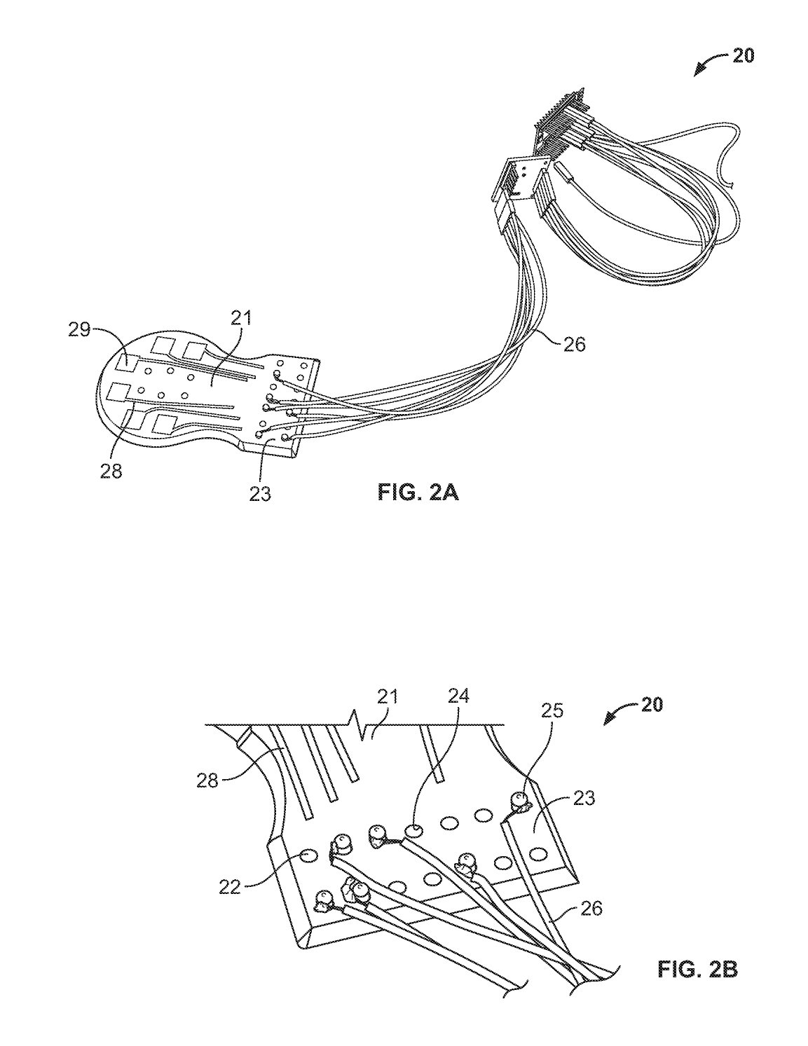

A variation to the single-part object 20 shown in FIGS. 2A and 2B is a multi-part object 30, as shown in FIGS. 3A-3C. The multi-part object 30 may be a 3D-printed capacitive touchpad having a plurality of printed electrically conductive pads 39 and indication LEDs embedded in the structural material. Each of the pads 39 and LEDs is internally electrically connected to a corresponding, e.g., nickel-coated rare earth, magnet 32 formed in a 7×2 array. Indication LEDs on the touchpad 30 may light up when, for example, a user's finger comes into close proximity of the corresponding pad 39.

Advantageously, in implementations in which, for example, the electronics needed to monitor capacitance are not embedded inside the object 30 and/or the electronics needed to analyze capacitance, which may require each of the magnets 32 to be connected to an external electronics platform (e.g., an Arduino board manufactured by Adafruit Industries), providing a remote connection may be accomplished by employing a male connection adapter 35 that attaches to the female magnetic connection array 33 of the touchpad.

More particularly, in some variations, the touchpad includes a base part 36, which may be very similar in design to the single-part object 10 described above, as well as a male connection mechanism 35 to create a plug or connector for more complex connections, such as USB or serial port connections. In some implementations, the base part 36 (FIG. 3A) includes a first portion 31 and an array portion 33. For illustrative purposes only, the array portion 33 includes a 7×2 array of sockets, each filled with a magnet 32. The magnets 32, which, in the sockets, are slightly recessed below the upper surface of the array portion 33, are electrically coupled to at least one, e.g., functional ink, trace 38 formed in the first portion 31 of the base part 36 and electrically coupled to a corresponding contact pad 39.

In some implementations, the male connection mechanism 35 (FIG. 3B) is an elongate, 3D polygonal structure having an upper surface 37a, an opposing lower surface 37b, and a plurality of, e.g., four, sidewalls, Although embodiments of the invention will be described as having a box-like male connection mechanism 35 with four sidewalls, the invention is not to be construed as being limited thereto. Indeed, the male connection mechanism 35 may include any number of sidewalls to be, for example, octahedral, hexahedral, and so forth.

A plurality of leads 26 may be routed through one or more of the sidewalls, each lead being soldered or otherwise attached to a 3D printed, electrically conductive trace formed within the 3D-printed male connection mechanism 35. The trace may be electrically and mechanically coupled to a magnet 32, with or without a magnetic contact pad. When in proper registration, the recessed magnet 32 can be electrically and magnetically coupled to at least one of an electrically conductive metal ball 34, an elongate cylinder, a wedding cake cylinder that has a stepped diameter that decreases from one end of the magnet 32 to the other, and the like. In one variation, the male connection adapter 35 may include a plurality of nickel-coated steel balls 34 electrically and mechanically attached to the leads 26 of a ribbon cable.

The sockets or cavities for the electrically conductive metal balls 34 are structured and arranged to fit loosely enough for the electrically conductive metal balls 34 to slide, e.g., uniaxially, within the socket or cavity, while preventing the electrically conductive metal balls 34 from coming completely out of the socket opening. In one implementation, at the socket or cavity opening, the sockets have a diameter that is 0.2 mm smaller than the diameter of the electrically conductive metal ball 34, so that some portion of the electrically conductive metal ball 34 can protrude from the part far enough to make solid magnetic and electrical connection to the female/magnet side. An assembled multi-part touchpad 30 is shown in FIG. 3C with the male connection adapter 35 electrically and magnetically coupled to the array portion 33 of the base part 36, such that the lower surface 37b is exposed.

Although this embodiment of the invention is described such that electrically conductive metal balls 34 are formed on and exposed through sockets on the male connection adapter 35, those of ordinary skill in the art can appreciate that the electrically conductive metal balls 34, elongate cylinders, wedding cake cylinders, and the like could, alternatively, be formed in the array portion 33 of the base part 36. Optionally, the 7×2 arrays of each of the male connection adapter 35 and the array portion 33 of the base part 36 may include one row having four electrically conductive metal balls 34 alternating between three magnet-filled sockets and one row with three electrically conductive metal balls 34 alternating between four magnet-filled sockets.

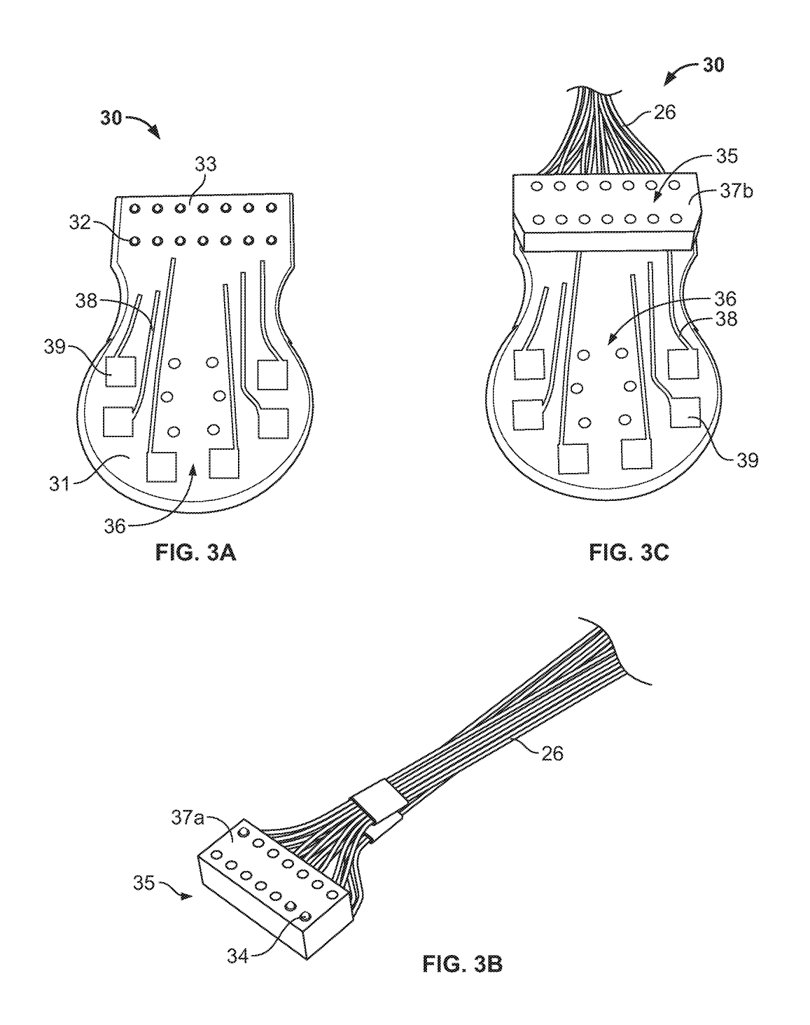

Magnetic electrical connections enable the creation of modular 3D-printed parts and multi-part objects that can be joined together in various combinations and permutations, in order to perform different functions. For example, FIGS. 4A and 4B show an embodiment of a multi-part object 40 that includes a base part 43 and three selectively attachable and removable parts or blocks 44, 46, 48. For illustrative purposes only, a first block may be a microcontroller 46 or include logic circuitry, a second block 48 may be a power source 49 (e.g., a battery), and a third block 44 may perform various functions such as locomotion, video recording, sensing, noise creation; provide a user interface (e.g., displays, buttons, etc.); and/or provide other input/output capabilities. Advantageously, modularity and reconfigurability are enabled by forming all of the blocks 44, 46, 48, which may resemble Lego® bricks, to include a standard array of electrical connections 45 and electrically conductive printed pads 42 to magnetically hold the parts 44, 46, 48 and the base part 43 together, while creating robust electrical connections. Indeed, FIGS. 4A and 4B show blocks 44, 46, 48 each having a plurality of electrical connections 45 and the base part 43 having a plurality of 3D-printed protrusions 41 into which magnets 42 have been embedded or otherwise disposed. As previously described, the electrical connections 45 and electrically conductive printed pads 42 hold the parts 44, 46, 48 to the base part 43 and provide electrical communication between the parts 44, 46, 48. The connecting posts 47 are optional.

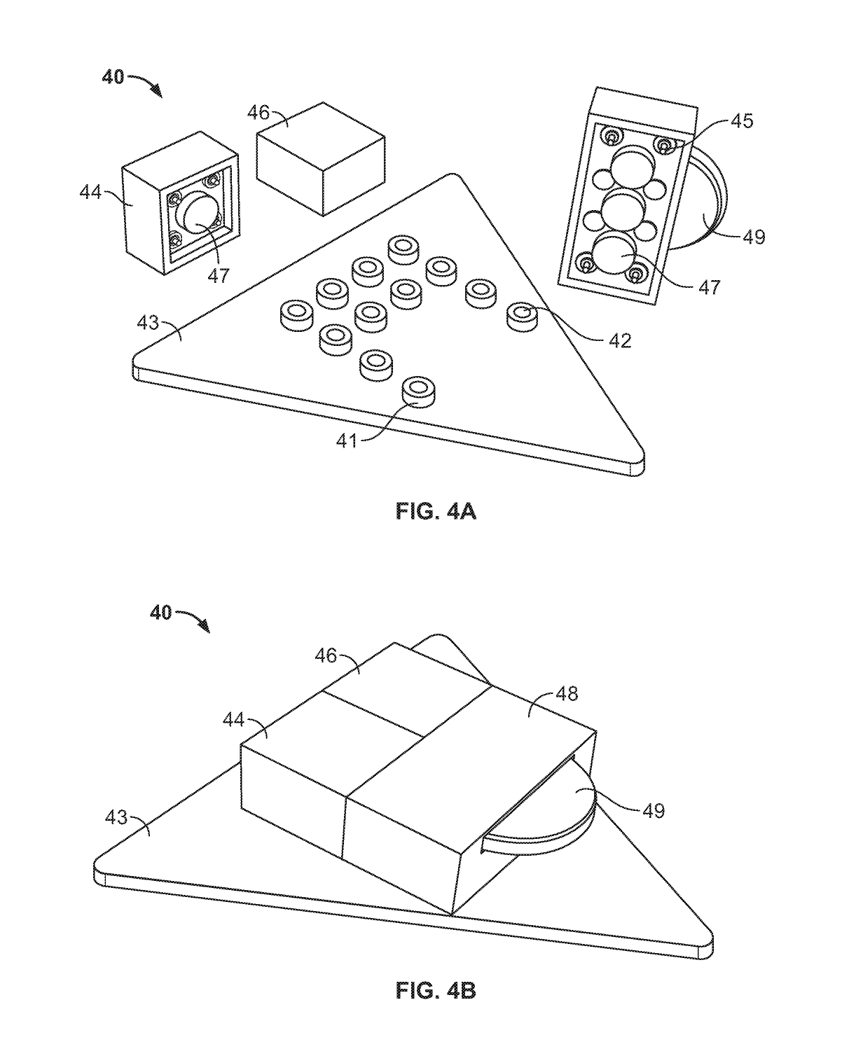

Referring to FIG. 5, in an illustrative embodiment, an object 50 includes a magnetic connection for magnetically connecting a 3D-printed first part 54 having a male connection portion 58 and a 3D-printed second part 52 having female connection portion 59. Those of ordinary skill in the art can appreciate that in a variation to the following description, the male connection portion 58 may, instead, be formed on the second part 52 and the female connection portion 59 may be formed on the first part 54. In yet another variation, male 58 and female connection portions 59 may be formed on each of the first 54 and second parts 52.

As previously described, during 3D printing of the second part 52, a functional (e.g., electrically conductive, metal, e.g., copper, silver, gold, platinum, and the like) trace 55 may be printed on the surface of the second part 52 and/or within a channel formed in the second part 52. As the 3D printing continues, a socket for an electrically conductive magnet 53 may be formed proximate the trace 55. Before the trace material has solidified, a magnet 53 may be inserted into the socket and coupled to the trace 55 to provide a mechanical coupling and electrical communication between the trace 55 and the magnet 53. Optionally, before the magnet 53 is inserted into the socket and before the trace 55 material has solidified, a magnetic pad 51 may be inserted into the socket and coupled to the trace 55 to provide a mechanical coupling and electrical communication between the trace 55 and the magnetic pad 51.

During 3D printing of the first part 54, a lead channel(s) and a socket(s) or cavity(ies), can be formed in the male multi-connection portion 58. Channels may be formed for routing the leads 56 away from the socket or cavity. In some variations, the channels allow the leads 56 to slide, but include constraints, so as not to allow the ball 57 to slip out of, i.e., beyond the opening of, the socket. The provision of compliance allows the height of each individual ball 57 to self-adjust and to fabricate reliably and simultaneously all of the male connection portions 58.

The sockets or cavities are structured and arranged to fit loosely enough for the electrically conductive metal balls 57 to slide, e.g., uniaxially, within the socket or cavity, while preventing the electrically conductive metal balls 57 from coming completely out of the socket opening. In one implementation, at the socket or cavity opening, the sockets have a diameter that is 0.2 mm smaller than the diameter of the electrically conductive metal ball 57, so that some portion of the electrically conductive metal ball 57 can protrude from the socket far enough to make solid magnetic and electrical connection to the female/magnet side.

Advantageously, to simultaneously form more than two male connection parts 58 on the same object 50, the connection points preferably have some degree of compliance to account for inevitable dimensional errors that may occur. The source of this compliance can come from a variety of different structures and/or components. For example, when connecting magnetic pads to external metallic wires that are capped with a spherical magnet or ferromagnetic material, one can take advantage of the intrinsic compliance in the metallic wires by creating a socket that allows the ferromagnetic ball 57 to slide down the axis of the cavity without being able to exit the opening of the socket.

Mechanical-Type Electrical Connections and their Manufacture

A mechanical, i.e., non-magnetic, variation of electrical connections also enables the creation of modular 3D-printed parts and multi-part objects that can be joined together in various combinations and permutations, in order to perform different functions. A magnetic embodiment of the objects 40 depicted in FIGS. 4A and 4B has been described above. With the mechanical variation, connecting posts 47 formed on the underside of the parts 44, 46, 48 and the protrusions 41 on the base part 43 mechanically hold the parts 44, 46, 48 and the base part 43 together, while creating robust electrical connections. When the method of connecting parts 44, 46, 48 to the base part 43 is more mechanical, the, e.g., cylindrical, connecting posts 47 provide a frictional, tight, or interference fit with the plurality of, e.g., cylindrical, protrusions 41 on the base part 43. Magnetic connections 45 may be optional.

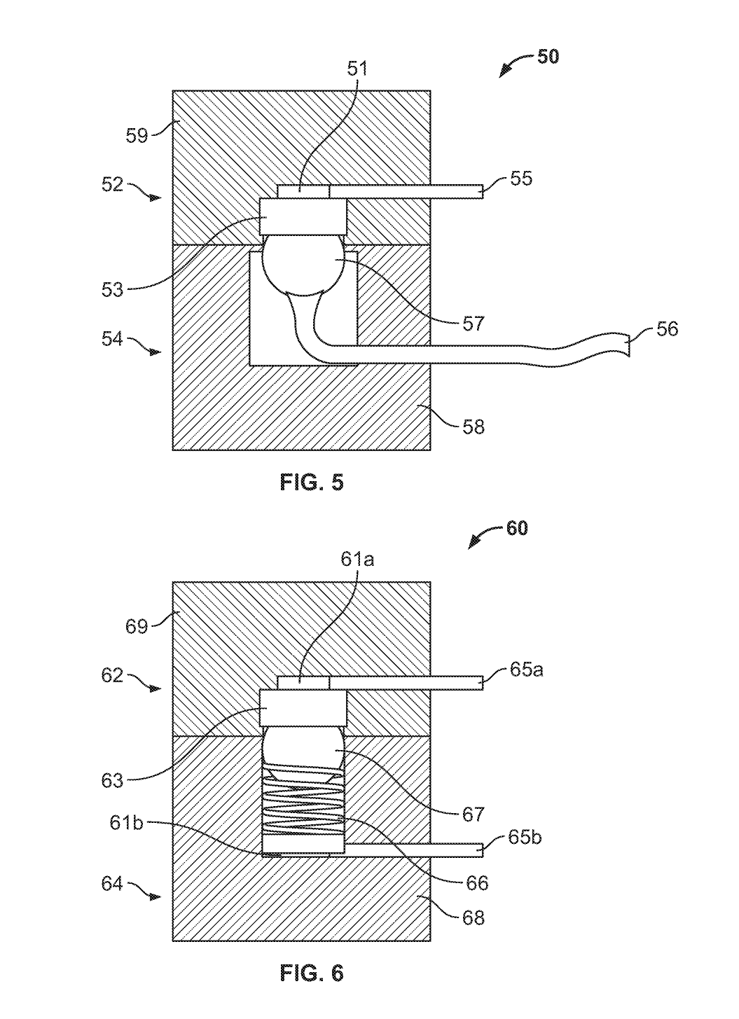

Referring to FIG. 6, an embodiment of an object 60 having a mechanical-type spring loaded contact connection is shown. Those of ordinary skill in the art can appreciate that, although the following description describes a variation in which a female connection portion 62 is formed in a first part 69 and a male connection portion 64 is formed in a second part 68, in another variation, the female connection portion 62 may, instead, be formed on the second part 68 and the male connection portion 64 may be formed on the first part 69. In yet another variation, male 64 and female connection portions 62 may be formed on the first part 69 and corresponding, opposing female 62 and male connection portions 64 may be formed on the second part 68.

As previously described, during 3D printing of the first part 69, a functional (e.g., electrically conductive, metal, e.g., copper, silver, gold, platinum, and the like) trace 65a may be printed on the surface of the part 69 and/or within a channel formed in the part 69. As the 3D printing continues, a socket for an electrically conductive magnet 63 may be formed proximate the trace 65a. Before the trace material has cooled and solidified, a magnet 63 may be inserted into the socket and coupled to the trace 65a to provide a mechanical coupling and electrical communication between the trace 65a and the magnet 63. Optionally, before the magnet 63 is inserted into the socket and before the trace material has cooled and solidified, a magnetic pad 61a may be inserted into the socket and coupled to the trace 65a to provide a mechanical coupling and electrical communication between the trace 65a and the magnetic pad 61a.

During 3D printing of the second part 68, a functional (e.g., electrically conductive, metal, e.g., copper, silver, gold, platinum, and the like) trace 65b may be printed on the surface of the part 68 and/or within a channel formed in the part 68. As the 3D printing continues, a socket or cavity may be formed proximate the trace 65b. Before the trace material has cooled, a magnetic pad 61b may be inserted into the socket and coupled to the trace 65b to provide a mechanical coupling and electrical communication between the trace 65b and the magnetic pad 61b. For the male multi-connections 64 between the two 3D-printed parts 68, 69, a compliant, electrically conductive spring 66 may electrically couple a mechanically biased, e.g., a spring-biased, semi-protruding ferromagnetic material 67, e.g., an electrically conductive metal ball 67, to the printed trace 65b, e.g., via the magnetic pad 61b, so that there is compliance on the male side. The socket or cavity of the male connection portion 64 is structured and arranged to be loose fitting enough for the spring 67 and the electrically conductive metal ball 67 to slide, e.g., uniaxially, within the socket or cavity. In FIG. 6, electricity flows from the top conductive trace 65a, through the disk magnet 63 coating, through the spherical ferromagnetic material 67 coating, through the spring 66, into the pad 61b, and finally into the bottom printed conductive trace 65b.

An alternative is to insert commercially available electrically conductive spring contacts and use magnets of a mechanical interlock to provide the downforce, rather than make the electrical connections themselves. For example, in some variations, a fully embedded magnet may be included with the male connection portion 68 described above. The magnet provides an attractive force to hold the electrically conductive spring contact to a conductive pad, e.g., on a female connection portion. Indeed, when making connection between printed electrically conductive traces 65a, 65b formed in multiple 3D-printed parts 68, 69, a source of compliance may be added since the electrically conductive traces 65a, 65b remain bonded to the matrix material. The source of compliance may be an electrically conductive spring 66 that creates an electrical connection between the trace 65b (or a metallic pad 61b placed on top of the trace 65b), and a pin or sphere 67 that makes direct contact with the electrically conductive magnet 63 or with a conductive female pad 61a. If there is an attractive magnetic force between the female metallic pad 61a and the pin or sphere 67, then additional magnets may not be needed to ensure a suitable mechanical connection. However, if there is no or minimal attractive force between the two, then additional magnets, which are not electrically coupled to the traces 65a, 65b, may be added to ensure a suitable connection between the parts 62, 64 that are meant to connect. In the last case, the magnets may be completely embedded under the surface.

Some electrical components may be too complex to print and/or have no reason to be printed and/or customized. In such instances, it may be more efficient to embed small complex modules, e.g., printed circuit boards (PCBs), in the 3D-printed object and to electrically connect multiple modules together, e.g., using 3D-printed conductors. In such cases, there are a variety of motifs to connect them. For example, in a first implementation, electrically conductive spring contacts or other biasable interconnects that are electrically conductive may be embedded in the 3D-printed object, such that the electrically conductive spring contacts line up with electrically conductive pads on the PCB. Electrical connections are made when the conductive pads of the PCB are pressed onto corresponding electrically conductive spring contacts. As a result, the PCB would then be mechanically attached to the electrically conductive spring contacts.

In another implementation, electrically conductive spring contacts or other biasable connections may be formed on the PCB and conductive pads and/or conductive sockets may be printed in the 3D-printed object, such that the conductive pads and/or conductive sockets line up with and/or are in registration with the electrically conductive spring contacts on the PCB. As a result, when an external, interlocking force is applied, the PCB would be electrically connected to the electrically conductive spring contacts, via the electrically conductive spring contacts.

The fabrication of 3D-printed parts, including embedded electronic devices and embedded conductive filaments, is described in International Patent Application Publication Number WO 2014/209994 to Lewis et al., the disclosure of which is incorporated herein in its entirety.

### EXEMPLARY APPLICATIONS

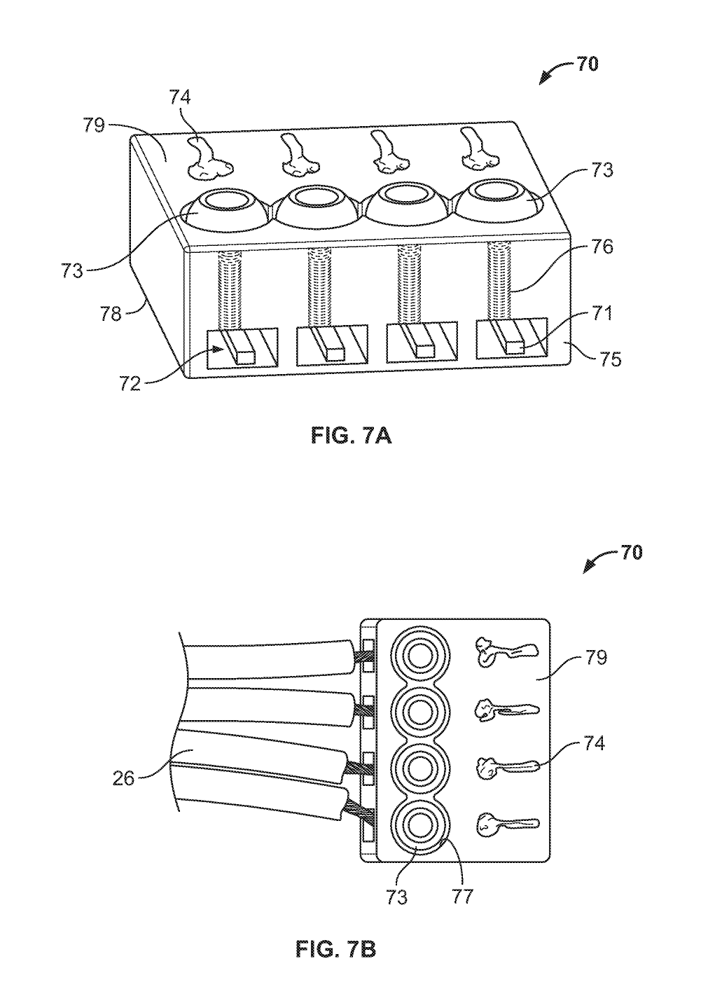

FIGS. 7A and 7B show an illustrative practical application of the present invention for a 3D-printed object 70 that defines a screw terminal. After 3D printing the bottom portion 78, e.g., using a structural material, a desired number of, e.g., four, traces 71 may be printed, e.g., using a functional (e.g., electrically conductive, metal, e.g., copper, silver, gold, platinum, and the like) ink, on the surface of the bottom portion 78 and/or within a channel formed in the bottom portion 78. Although the screw terminal in the figures includes four traces 71, that is done for illustrative purposes only. Those of ordinary skill in the art can appreciate that 3D-printed screw terminals having more or fewer traces 71 can be manufactured using the methods described herein.

As 3D printing continues, e.g., using a structural material, a plurality of 3D-printed walls 75 creates corresponding lead apertures 72 about each trace 71 for receiving leads 26. Screw apertures 76, e.g., elongate, cylindrical holes, for receiving electrically conductive, metallic screws 73, may be formed directly above the traces 71. The diameter of the screw apertures 76 is selected to mesh with the outer diameter of the electrically conductive, metallic screws 73. A plurality of countersinks 77 may be formed in the upper surface 79 of screw terminal 70 to accommodate the head of the screw 73. Finally, an equal number of, e.g., four, traces 74 may be printed, e.g., using a functional (e.g., electrically conductive, metal, e.g., copper, silver, gold, platinum, and the like) ink, on the upper surface 79 and/or within a channel formed in the upper surface 79, such that, when an electrically conductive, metallic screw 73 is inserted into the screw aperture 76, the screw head electrically couples the screw 73 to the trace 74. Accordingly, once leads 26 are inserted into each aperture 72 and the distal end of an electrically conductive, metallic screw 73 mechanically and electrically couples the lead 26 to the trace 71 on the lower portion 78, the screw 73 provides electrical communication between the pair of traces 71, 74.

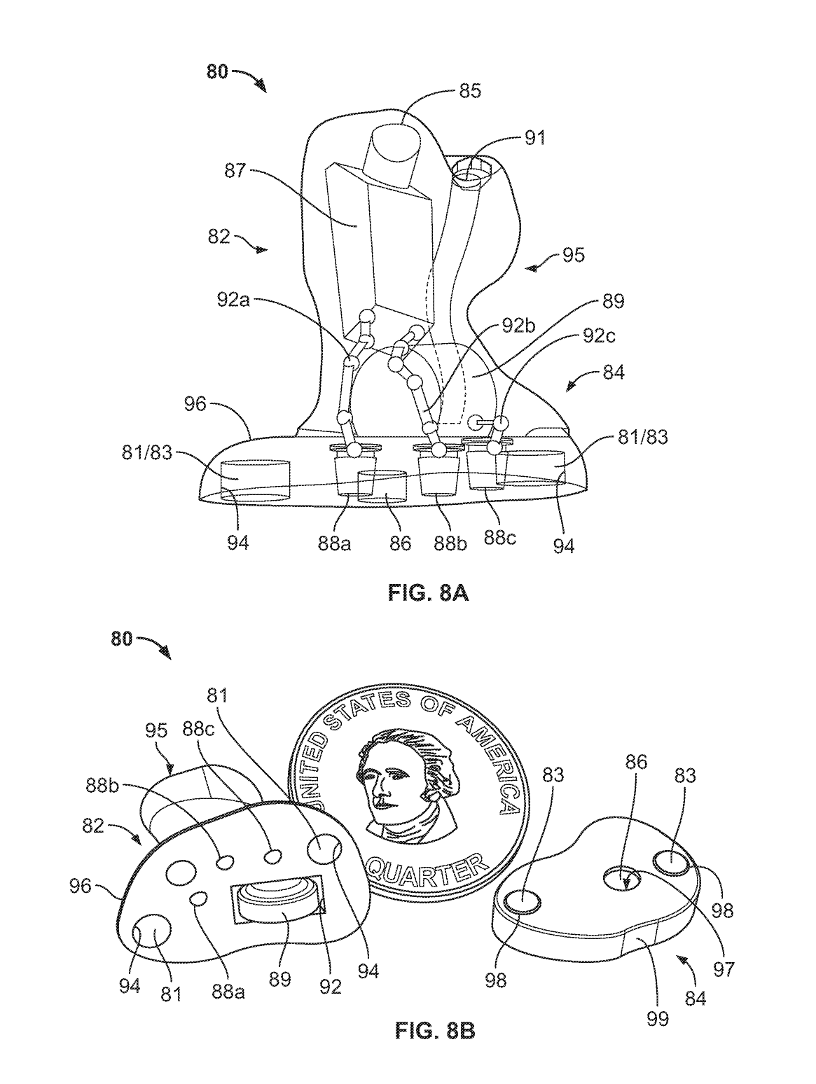

FIGS. 8A and 8B show an illustrative practical application of an embodiment of the present invention for a 3D-printed object 80 that defines a hearing (aid) device. In some implementations, the device includes an intra-ear portion 82 and an external portion 84 that may be magnetically or mechanically coupled using corresponding magnets 81, 83 that are structured and arranged to attract each other. In one variations, the external portion 84 includes a 3D-printed body 99 in which a plurality of openings or sockets 97, 98 is formed. Each of a pair of sockets 98 is configured for receiving a magnet 83 or magnetic material.

The other opening 97 may be configured for receiving a microphone 86. Electrical connections 88a and 88b provide power to the microphone 86 via corresponding electrically conductive contact pads. In another variation, the external portion may be a PCB. Indeed, the entire external portion 84 of the hearing aid may be a mockup of the shape of a potential amplifier circuit, in which case, the external portion 84 may be mechanically coupled, e.g., snap-fitted, to circuitry that turns the hearing aid on and off. Advantageously, this latter variation facilitates exposing the battery interconnects for easy recharging and makes the amplifier and logic module upgradeable.

In some embodiments, the intra-ear portion 82 includes an upper ear mold 95 and a lower portion 96 that are 3D-printed monolithically. A plurality of openings 93 and/or sockets 92, 94 may be formed during 3D printing in the lower portion 96. A first socket 92 is structured and arranged to retain and house a power supply, e.g., a battery 89 and related wiring. A plurality of, e.g., three, openings 93 may be formed in the lower portion 96 for receiving electrical connections 88a, 88b, 88c from the power supply to the electrical components. The cathode or anode of the battery 89 provides a fourth contact.

Each of a pair of sockets 94 in the lower portion 96 is configured for receiving a magnet 81 or magnetic material. Preferably the polarity of the exposed portion of the magnets 81 in the lower portion 96 differs from the polarity of the exposed portion of the magnets 83 in the external portion 84. The sockets 94, 98 and magnets 81, 83 are structured and arranged to place the intra-ear portion 82 and the external portion 84 in registration with one another and to securely and reliably attached the portions 82, 84 to one another.

During 3D printing of the intra-ear portion 82, e.g., using a structural material, conduits in the intra-ear portion 82 are formed to provide a sound channel 85 and an (optional) vent hole 91. Plenum space within the intra-ear portion 62 is also formed for receiving and housing one or more of a speaker, an amplifier, and other circuitry 87, as well as conduits for receiving 3D-printed traces or electrical wire leads 92a, 92b, 92c that deliver power from the battery 89 to the speaker, amplifier, and other circuitry 87.

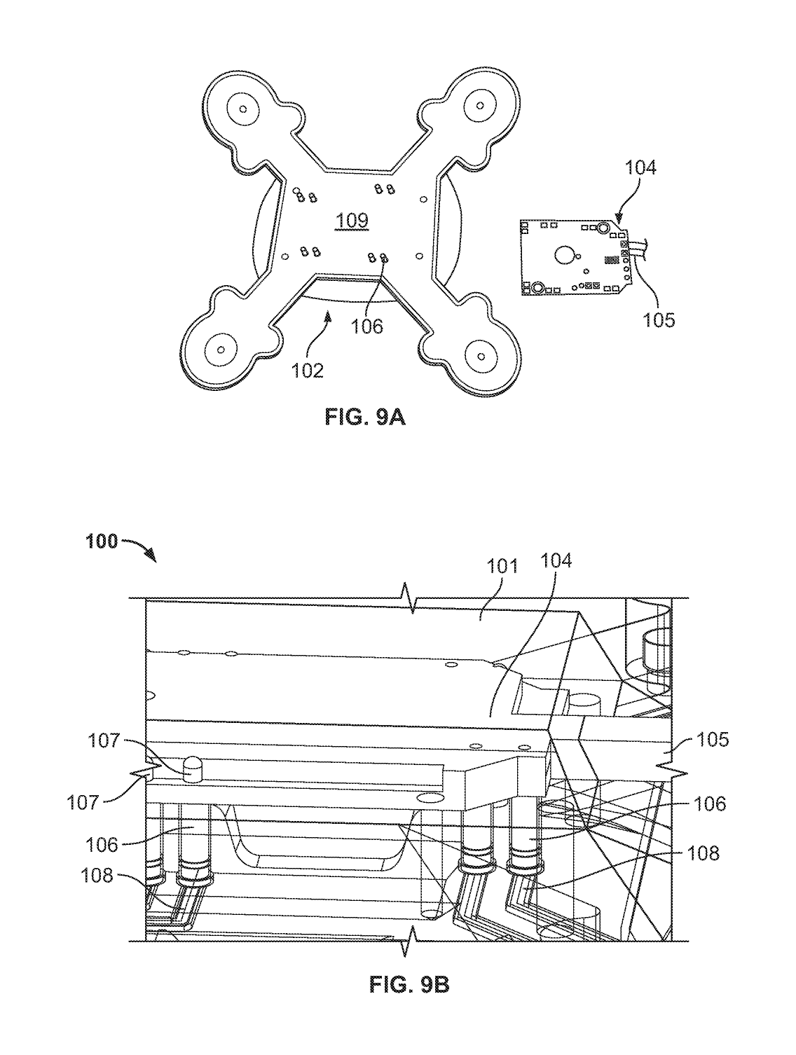

FIGS. 9A and 9B show another illustrative practical application of the present invention for an object 100 that is a multi-part drone 100, e.g., a quadcopter drone. In some applications, the drone 100 includes a PCB 104 that can be readily and repeatably attached to/removed from a 3D-printed drone body portion 102. In some implementations, the body portion 102 includes a base 109 through which a plurality of, e.g., eight, electrically conductive spring contact pins 106 and the like, are installed, embedded, and/or 3D-printed. The electrically conductive spring contact pins 106 are structured and arranged so that, when the PCB 104 is properly installed on the body portion 102, each of the electrically conductive spring contact pins 106 on the body portion 102 registers and/or aligns with a corresponding electrically conductive contact pad 107 formed in the PCB 104. Although the invention is described such that electrically conductive spring contact pins 106 are formed in the body portion 102 and the electrically conductive contact pads 107 are formed in the PCB 104, those of ordinary skill in the art can appreciate that the electrically conductive contact pins 106 could also be formed in the PCB 104 and the electrically conductive contact pads 107 formed in the body portion 102. Accordingly, either the PCB 104 or the 3D-printed body portion 102 may include a magnet (embedded or otherwise) or ferrous material.

As shown in FIG. 9B, each of the electrically conductive contacts pins 106 may be electrically coupled to a 3D-printed conductive lead 108 that provides electrical and/or electronic communication between the electrically conductive contact pins 106 and other components of the device 100. In some implementations, the PCB 104 is embedded or otherwise included in a 3D-printed encasement 101 that also encases an electrical and electronic communication lead 105.

An exemplary method of making an electrical connection for an object 100 such as a 3D-printed drone, may include forming a first part 101 of the printed object 100 by three-dimensional printing; embedding a printed circuit board 104 in the first part 101; forming a second part 102 of the object by three-dimensional printing, wherein some portion of the second part 102 includes embedded and/or 3D-printed electrically conductive leads 108; and coupling the first part 101 to the second part 102 such that, when the first and second parts are properly coupled, the printed circuit board 104 is in electrical communication with corresponding electrically conductive leads 108 in the second part. More specifically, forming the second part 102 may include forming electrically conductive pads 107 and/or electrically conductive sockets in the second part 102; and inserting uniaxially biasable electrically conductive objects 106 into the electrically conductive pads 107 and/or the electrically conductive sockets to make electrical connections at multiple locations on the printed circuit board 104.

In one variation, electrically conductive pads 107 and/or electrically conductive sockets are formed in the printed circuit board 104 for the purpose of orienting and holding, e.g., magnetically and/or mechanically, the printed circuit board 104 to corresponding biasable electrically conductive pins 106 formed on the second part 102. In another variation, the printed circuit board 104 is mechanically attached to the second 102, e.g., by a snap fit or an interference fit. Thus, the electrically conductive pins 106 of the second part 102 mechanically hold the entire PCB 104 using, for example, an interference fit with the electrically conductive pad 107, using a snap fit with the electrically conductive socket, using a snap fit with the electrically conductive pad 107, by screwing the printed circuit board 104 into the electrically conductive socket 107, and/or by inserting the printed circuit board 104 into the electrically conductive socket 107 and 3D printing over the printed circuit board 104. In yet another variation, the printed circuit board 104 is reversibly attached to the 3D-printed part 101 using magnetic force.

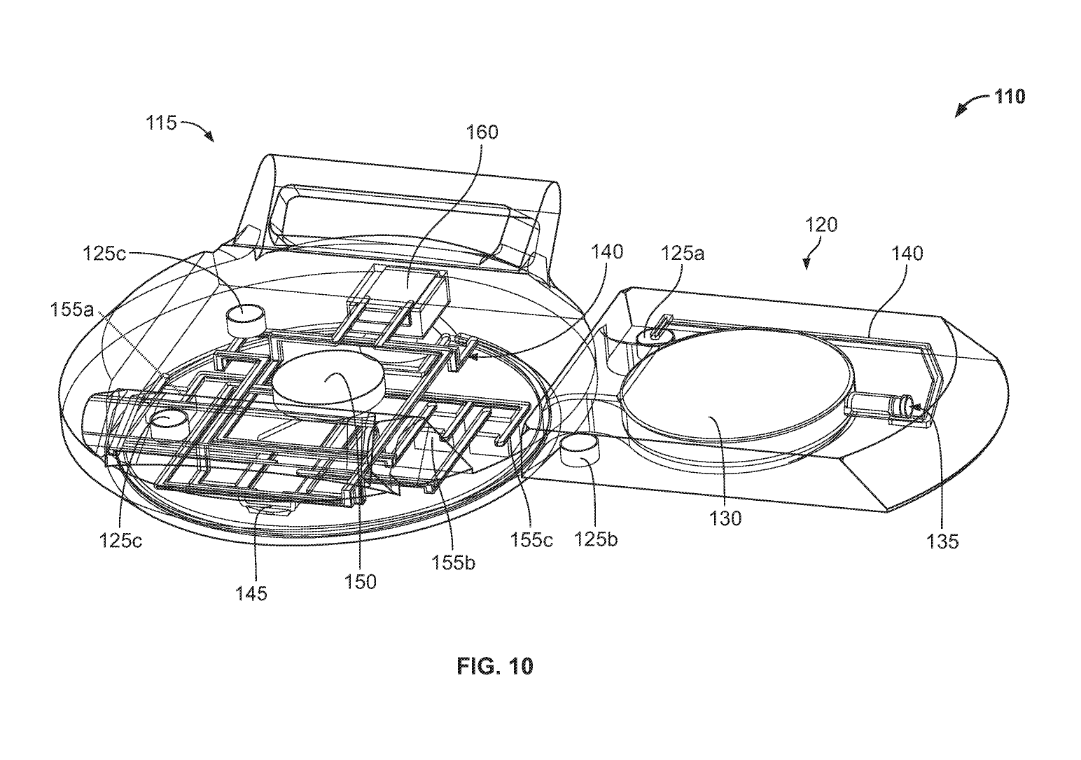

FIG. 10 shows yet another illustrative practical application of the present invention for an object 110 that is a watch. In some implementations, the object 110 includes a base portion 115 and a module 120 for a power supply, e.g., a battery 130, that is readily removable, e.g., slideable, from the base portion 115. In some variations, the power supply module 120 includes a pair of magnetic/electric interconnections 125a, 125b of a type described hereinabove. One of the connections 125a may be in electrical communication with the battery 130, e.g., via an electrically conductive spring contact 135 and a 3D-printed electrically conductive lead(s) 140.

In some implementations, the base portion 115 of the object 110 may include a processing device, e.g., a microcontroller 145; an oscillator 160, a corresponding pair of magnetic/electric interconnections 125c, 125d that are structured and arranged, when the removable module 120 is properly installed in the base portion 115, to register and/or align with the pair of magnetic/electric interconnections 125a, 125b in the removable module 120; and a magnetic/electric interconnect 150 that is structured and arranged, when the removable module 120 is properly installed in the base portion 115, to register and/or align with the battery 130. Three-dimensionally printed conductive leads 140 may be configured in the base portion 115 to provide electrical and electronic communication to the various components of the watch, e.g., a plurality of light emitting readouts 155a, 155b, 155c that display data, e.g., time, day of the week, date, and the like, on the watch face.

An exemplary method of making an electrical connection to a multi-part, three-dimensionally printed object 110, for example, for the watch in FIG. 10 may include forming a first part 150 of the printed object by three-dimensional printing. In some implementations, some portion of the first part 150 is elastic and compliant. In a next step, an electrically conductive feature may be three-dimensionally printing proximate the compliant first part. Preferably, at least some portion of the electrically conductive feature comprises an external biasable face. While forming a second part 120 of the object 110 by three-dimensional printing an electrically conductive pad and/or an electrically conductive socket is formed by printing conductive ink in a location that causes the conductive feature 150 of the first part 115, when the first 115 and second parts 120 are properly mechanically joined, to register and/or align with at the electrically conductive pad and/or the electrically conductive socket of the second part 120. For the watch, the anode of the power source 130 can be mechanically and electrically coupled to the magnetic/electric interconnect 150. In some variations, mechanical joining the battery 130 and the magnetic/electric interconnect 150 may cause a slight deflection of the electrically conductive feature 150, which ensures consistent, reliable electrical contact with the battery 130, the electrically conductive pad and/or the electrically conductive socket of the second part 120.

Those skilled in the art will readily appreciate that all parameters listed herein are meant to be exemplary and actual parameters depend upon the specific application for which the methods, materials, and apparatus of the present invention are used. It is, therefore, to be understood that the foregoing embodiments are presented by way of example only and that, within the scope of the appended claims and equivalents thereto, the invention may be practiced otherwise than as specifically described. Various materials, geometries, sizes, and interrelationships of elements may be practiced in various combinations and permutations, and all such variants and equivalents are to be considered part of the invention.

What is claimed is:

1. A method of making an electrical connection to a three-dimensionally printed object, the method comprising the steps of:
forming the printed object by three-dimensional printing, wherein the printed object defines a socket disposed proximate a printed electrically conductive lead in the printed object; and
inserting a magnet into the socket to form an electrical contact between the magnet and the electrically conductive lead.

2. The method of claim 1, wherein the forming step comprises three-dimensionally printing a portion of the object with a structural material and printing the electrically conductive lead with a functional material.

3-5. (canceled)

6. The method of claim 1, wherein the inserting step occurs prior to at least one of curing and drying of the electrically conductive lead.

7. (canceled)

8. The method of claim 1 further comprising, after inserting the magnet in the socket, printing a rim over a top edge of the magnet to retain the magnet.

9. The method of claim 1, further comprising the step of contacting the magnet with an external wire.

10-11. (canceled)

12. The method of claim 1, wherein the printed object defines a plurality of additional sockets proximate a plurality of additional electrical leads embedded in the printed object, the method further comprising the step of inserting additional magnets into the additional sockets to form additional electrical contacts.

13-21. (canceled)

22. The method of claim 1, further comprising using an electromagnetic head to automate the process of picking and placing magnets or ferromagnetic materials into three-dimensionally printed parts.

23-25. (canceled)

26. The method of claim 1, further comprising the step of using the magnet to actuate mechanical interlocking with a second printed object.

27. (canceled)

28. An article comprising:
a three-dimensionally printed object defining a socket disposed proximate an electrical lead embedded in the printed object; and
a magnet disposed in the socket, forming an electrical contact between the magnet and the electrical lead.

29. The article of claim 28, wherein the three-dimensionally printed object comprises a structural material and the electrical lead comprises a functional material.

30. The article of claim 28, wherein the magnet and the socket are dimensioned to provide an interference fit.

31. The article of claim 28, wherein an external wire contacts the magnet.

32-33. (canceled)

34. The article of claim 28, wherein the printed object defines a plurality of additional sockets proximate a plurality of additional electrical leads embedded in the printed object, and additional magnets are inserted into the additional sockets to form additional electrical contacts.

35-41. (canceled)

42. The article of claim 28, wherein the magnet comprises a conductive coating.

43. (canceled)

44. The article of claim 28, wherein the socket and magnet define complementary shapes.

45. (canceled)

46. The article of claim 28, wherein the magnet is fully embedded in the socket, and attracts a contact pin into the socket to form an electrical contact between the contact pin and a conductive pad in the socket.

47. (canceled)

48. The article of claim 47, wherein the socket defines a slot and the second printed object defines a printed protrusion that fits into the slot.

49. A method of making an electrical connection to a multi-part, three-dimensionally (3D) printed object, the method comprising the steps of:
forming a first part of the printed object by three-dimensional printing, wherein a socket is formed in the first part proximate a first electrically conductive lead, the first part further comprising at least one press-fit part;
inserting an electrically conductive material into the socket in the first part to form an electrical contact between the material and the first electrically conductive lead;
forming a second part of the printed object by three-dimensional printing, wherein a socket is formed in the second part proximate a second electrically conductive lead, the second part further comprising at least one press-fit part;
inserting a biasable, electrically conductive object into the socket in the second part to form an electrical contact between the electrically conductive object and the second electrically conductive lead; and
press-fitting the first part to the second part to mechanically connect the first part to the second part and to form an electrical communication between the first electrically conductive lead and the second electrically conductive lead.

50. The method of claim 49, wherein the biasable, electrically conductive object comprises a metallic sphere electrically coupled to a spring.

51. The method of claim 49, wherein the biasable, electrically conductive object comprises a spring-loaded electrically conductive pin.

52. The method of claim 49, wherein the wherein the biasable, electrically conductive object holds the three-dimensionally printed object in an electrically coupled position and orientation via a three-dimensionally printed mechanical interlocking feature.

53-61. (canceled)
